(19) United States
(12) Patent Application Publication
(10) Pub. No.: US 2007/0162897 A1
(43) Pub. Date: Jul. 12, 2007

(54) Apparatus and method for profiling based on call stack depth

(75) Inventors: Scott N. Gerard, Rochester, MN (US); John Matthew Santosuosso, Rochester, MN (US)

Correspondence Address: MARTIN & ASSOCIATES, LLC, P.O. BOX 548, CARTHAGE, MO, 64836-0548, US

(73) Assignee: INTERNATIONAL BUSINESS MACHINES CORPORATION, ARMONK, NY (US)

(21) Appl. No.: 11/330,682

(22) Filed: Jan. 12, 2006

(51) Int. Cl. G06F 9/44

(52) U.S. Cl. 717/130

(57) ABSTRACT

A profiler collects profile data according to a defined trigger specification, a defined level specification, and an optional defined skip specification. The profiler begins collecting profile data when the trigger specification is satisfied. The profiler monitors stack frames on a call stack, and collects profile data for the defined level from the current stack frame. A skip specification may also be defined that allows skipping the collecting of profile data for specified jar files, packages, classes, or methods. In this manner, a profiler may collect profile data up to a specified level from the current stack frame while specifically skipping the collection of profile data according to the defined skip specification.

### BACKGROUND OF THE INVENTION

1. Technical Field

This invention generally relates to computer systems, and more specifically relates to measuring performance of a computer program by profiling.

2. Background Art

The ability to measure the performance of a computer program is crucial to the process of optimizing the computer program to provide the best performance possible. There are many ways to measure performance of a computer program. One known way is referred to in the art as profiling. Profiling measures the performance of a computer program. A profiler typically keeps track of program execution by logging certain events as they occur. For example, a profiler may log every entry into and every exit from a module, subroutine, method, function, or system component. Alternately, a profiler may log the requester and the amounts of memory allocated for each memory allocation request. Typically, a time stamped record is produced for each such event. Pairs of records similar to entry-exit records also are used to trace execution of arbitrary code segments, to record requesting and releasing locks, starting and completing I/O or data transmission, and for many other events of interest. The log information produced by a profiler is typically referred to as a “trace.”

Profilers are generally event-based or sampling. An event-based profiler inserts instrumentation code into the program to collect the needed information. For example, if the performance of a method needs to be measured, a first instruction could be added at the beginning of the method and a second instruction could be added at the end of the method. These two instructions could increment one or more counters, thereby providing information regarding how often the method is executed. An event-based profiler is intrusive because it requires the insertion of instrumentation instructions in the computer program being measured. The presence of the additional instructions has the ability to affect the performance of the computer program. Another type of profiler is a sampling profiler, which samples the instruction currently being executed at defined time intervals. A sampling profiler typically provides less data, and the data is less reliable than event-based profilers. Note, however, that a sampling profiler does not add any instrumentation instructions to the computer program, and therefore does not affect the run-time performance of the computer program as much as an event-based profiler.

Java programs have a call stack that includes stack frames that correspond to called methods. Known profilers allow collecting profile data when a particular method is executed. However, methods are often nested many levels deep, and specifying to collect profile data for one method may result in collecting profile data for hundreds or even thousands of methods that are invoked during the execution of the one method. When a great deal of profile data is collected, it is difficult to process the data to locate the data that is of interest. Without a way to selectively collect profile data based on call stack information, the computer industry will continue to suffer from inefficient tools for profiling a computer program.

### Disclosure of Invention

According to the preferred embodiments, a profiler collects profile data according to a defined trigger specification, a defined level specification, and an optional defined skip specification. The profiler begins collecting profile data when the trigger specification is satisfied. The profiler monitors frames on a call stack, and collects profile data for the defined level from the current stack frame. For example, the defined level may be three, meaning that profile data should be collected for stack frames up to three levels deep from the current stack frame. A skip specification may also be defined that allows skipping the collecting of profile data for specified jar files, packages, classes, or methods. In this manner, a profiler may collect profile data up to a specified level from the current stack frame while specifically skipping the collection of profile data according to the defined skip specification. The result is a profiler that is very flexible in collecting data of interest in a focused manner that helps the programmer to avoid collecting data that is not of interest.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of an apparatus in accordance with the preferred embodiments;

FIG. 2 is flow diagram of a method for setting up profiling in accordance with the preferred embodiments;

FIG. 3 is a sample trigger specification in accordance with the preferred embodiments;

FIG. 4 is a sample level specification in accordance with the preferred embodiments;

FIG. 5 is a first sample skip specification in accordance with the preferred embodiments;

FIG. 6 is a second sample skip specification in accordance with the preferred embodiments;

FIG. 7 is a flow diagram of a method for performing profiling in accordance with the preferred embodiments;

FIG. 8 shows sample code used to illustrate the preferred embodiments;

FIG. 9 shows a sample state of the call stack when the ProductInfo.execute() method of FIG. 8 is invoked;

FIG. 10 shows a sample state of the call stack when the reset() method of FIG. 8 is invoked during the execution of ProductInfo.execute(1); and

FIG. 11 shows a sample state of the call stack when the reset() method of FIG. 8 is invoked during the execution of ProductInfo.execute(3).

### BEST MODE FOR CARRYING OUT THE INVENTION

The preferred embodiments enable collecting profile data based on call stack information. A trigger specification, level specification and optional skip specification are defined for the collection of profile data. When the trigger specification is satisfied, profile data is collected for a number of stack frames up to the number of levels from the current stack frame as specified in the level specification. The optional skip specification allows specifying a JAR file, package, class, or method, which means the profiler will not collect profile data for skipped methods, and those skipped methods will not count in the levels. In this manner, detailed profile data for a particular portion of code may be obtained while excluding less relevant data.

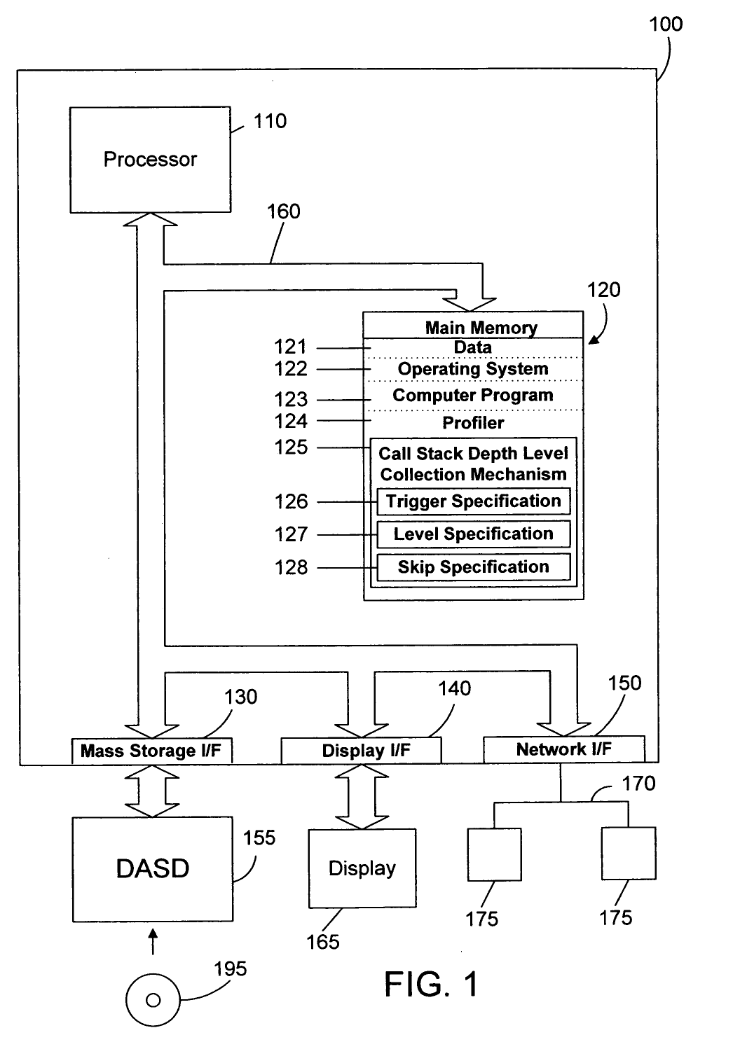

Referring to FIG. 1, a computer system 100 is one suitable implementation of an apparatus in accordance with the preferred embodiments of the invention. Computer system 100 is an IBM eServer iSeries computer system. However, those skilled in the art will appreciate that the mechanisms and apparatus of the present invention apply equally to any computer system, regardless of whether the computer system is a complicated multi-user computing apparatus, a single user workstation, or an embedded control system. As shown in FIG. 1, computer system 100 comprises a processor 110, a main memory 120, a mass storage interface 130, a display interface 140, and a network interface 150. These system components are interconnected through the use of a system bus 160. Mass storage interface 130 is used to connect mass storage devices, such as a direct access storage device 155, to computer system 100. One specific type of direct access storage device 155 is a readable and writable CD RW drive, which may store data to and read data from a CD RW 195.

Main memory 120 in accordance with the preferred embodiments contains data 121, an operating system 122, a computer program 123, and a profiler 124. Data 121 represents any data that serves as input to or output from any program in computer system 100. Operating system 122 is a multitasking operating system known in the industry as i5/OS; however, those skilled in the art will appreciate that the spirit and scope of the present invention is not limited to any one operating system. Computer program 123 is any suitable computer program for which a user may decide to collect profile data using profiler 124. Profiler 124 includes a call stack depth level collection mechanism 125 that collects profile data based on a trigger specification 126, a level specification 127, and an optional skip specification 128. The trigger specification 126 specifies when to begin collecting profile data. In the most preferred implementation, trigger specification 126 specifies an object oriented method, the execution of which will trigger collection of profile data. The level specification is preferably a positive integer that specifies how many levels in the call stack to collect profile data. Thus, if the level specification is set to three, profile data will be collected for the current level plus three additional levels. This means that profile data for stack frames beyond three levels deep would not be collected. The skip specification specifies a JAR file, package, class or method. If a method satisfies the skip specification, the method is not counted in the levels of the call stack. This allows collecting pertinent profile data while avoiding extraneous or less relevant profile data.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, computer program 123, and profiler 124 are shown to reside in main memory 120, those skilled in the art will recognize that these items are not necessarily all completely contained in main memory 120 at the same time. It should also be noted that the term “memory” is used herein to generically refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122. Operating system 122 is a sophisticated program that manages the resources of computer system 100. Some of these resources are processor 110, main memory 120, mass storage interface 130, display interface 140, network interface 150, and system bus 160.

Although computer system 100 is shown to contain only a single processor and a single system bus, those skilled in the art will appreciate that the present invention may be practiced using a computer system that has multiple processors and/or multiple buses. In addition, the interfaces that are used in the preferred embodiments each include separate, fully programmed microprocessors that are used to off-load compute-intensive processing from processor 110. However, those skilled in the art will appreciate that the present invention applies equally to computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150. Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of computer-readable signal bearing media used to actually carry out the distribution. Examples of suitable computer-readable signal bearing media include: recordable type media such as floppy disks and CD RW (e.g., 195 of FIG. 1), and transmission type media such as digital and analog communications links. Note that the preferred signal bearing media is tangible.

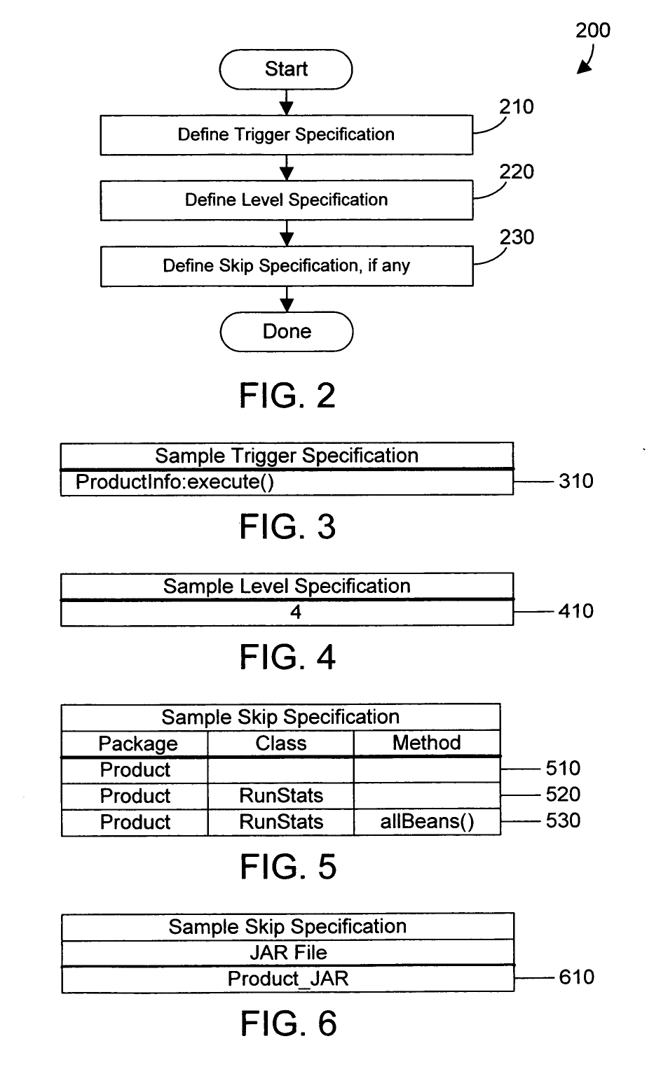

Referring to FIG. 2, a method 200 in accordance with the preferred embodiments shows the steps that are performed to setup profiling in accordance with the preferred embodiments. A trigger specification is defined (step 210). As stated above, the trigger specification is preferably an object oriented method. A sample trigger specification is shown at 310 in FIG. 3. When the object oriented method is executed, collecting of profile data begins. Note, however, than any suitable way to trigger the collection of profile data by a profiler is within the scope of the trigger specification 126 (FIG. 1) of the preferred embodiments.

A level specification is also defined (step 220). The level specification determines how many levels deep in the call stack the profiler will go in collecting profile data. For levels greater than the level specification, profile data is not collected. A sample level specification of four is shown at 410 in FIG. 4. This means the profiler will not collect profile data for any stack frames that are deeper than four levels from the current stack frame, unless one of those levels satisfies the skip specification, as explained below.

A skip specification may also be defined (step 230). As explained above, the skip specification may specify a JAR file, a package, a class, or a method to skip. FIGS. 5 and 6 show different examples of skip specification. If only a package is specified as shown at 510, all methods in that package will be skipped. Thus, for the sample skip specification at 510 in FIG. 5, all methods in the Product package will be skipped. If a package and class are specified as shown at 520, all methods in that class will be skipped. Thus, for the sample skip specification at 520 in FIG. 5, all methods in the RunStats class in the Product package will be skipped. If a package, class and method are specified as shown at 530, the specified method will be skipped. Thus, for the sample skip specification at 530 in FIG. 5, the allBeans() method in the RunStats class in the Product package will be skipped. Another sample skip specification is shown in FIG. 6 to specify a JAR file. The JAR file Product_JAR is specified at 610 in FIG. 6. Thus, all methods in all packages and classes in the JAR file Product_JAR will be skipped.

When a frame is placed on the call stack for a method, the profiler determines whether the method satisfies the skip specification. If so, the profiler does not collect profile data for the method, and does not count the level of the stack frame against the level in the level specification. If the method does not satisfy the skip specification, and is within the level specification, the profiler collects profile data for the method, and counts the level of the stack frame against the level in the level specification.

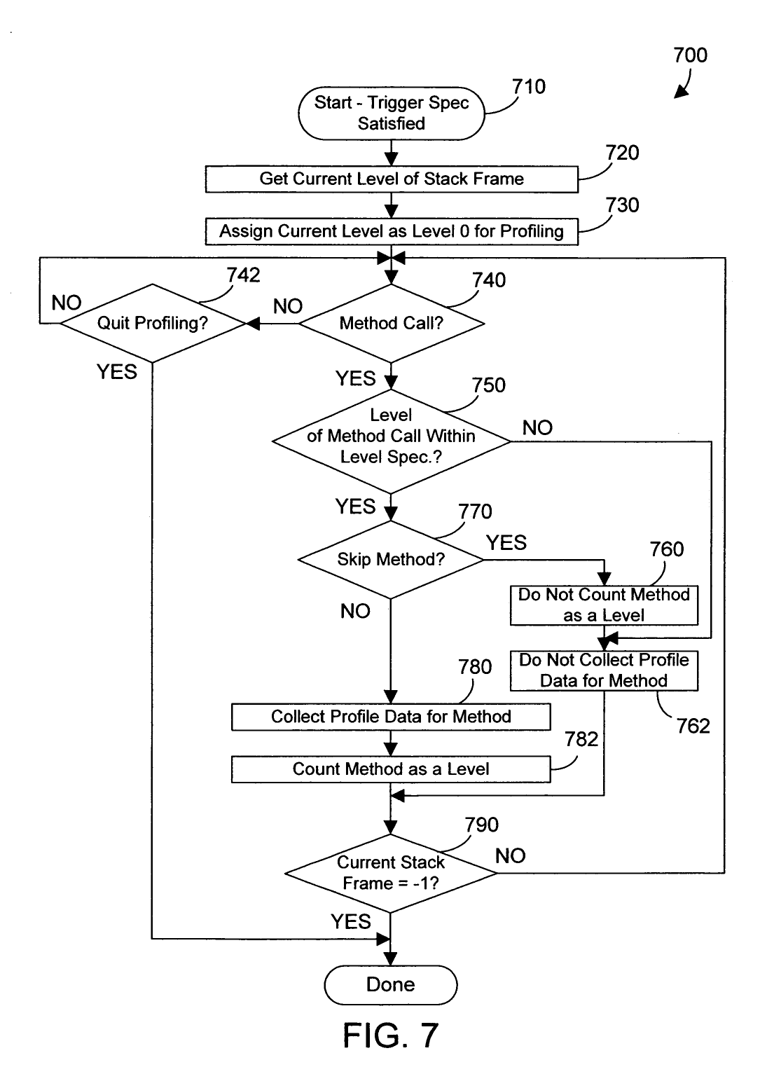

Referring to FIG. 7, a method 700 shows the steps performed by the profiler of the preferred embodiments after the trigger specification, level specification, and skip specification are defined as shown in method 200 in FIG. 2. Method 700 begins when the trigger specification is satisfied (step 710). The current level of the stack frame is determined (step 720) and assigned as Level 0 for profiling (step 730). Method 700 then waits for a method call. If no method call is received (step 740), and if profiling needs to end (step 742=YES), method 700 is done. If profiling needs to continue (step 742=NO), method 700 returns to step 740 to await a method call. When a method call occurs (step 740=YES), as indicated by a new stack frame being created for the method, the profiler determines whether the level of the stack frame for the method call is within the level specification (step 750). If not (step 750=NO), no profile data is collected for the method (step 762). If the level of the stack frame created for the method call is within the level specification (step 750=YES), method 700 next determines whether to skip the method (step 770). If the method satisfies the skip specification (step 770=YES), the stack frame for the method is not counted against the level specification (step 760), and profile data is not collected for the method (step 762). If the method does not satisfy the skip specification (step 770=NO), profile data is collected for the method (step 780) and the method is counted against the level specification (step 782). If the current stack frame level is not −1 (step 790=NO), method 700 loops back to step 740 and continues. Once the current stack frame level is −1 (step 790=YES), method 700 is done.

The combination of the trigger specification, the level specification, and the skip specification provide a powerful new profiler for profiling a computer program. Profiling begins when the trigger specification is satisfied. Profiling continues for the levels in the call stack that satisfy the level specification. Methods are skipped that satisfy the skip specification, and the stack frames of skipped methods do not count against the level specification. The result is a powerful and flexible tool for selectively profiling portions of a computer program.

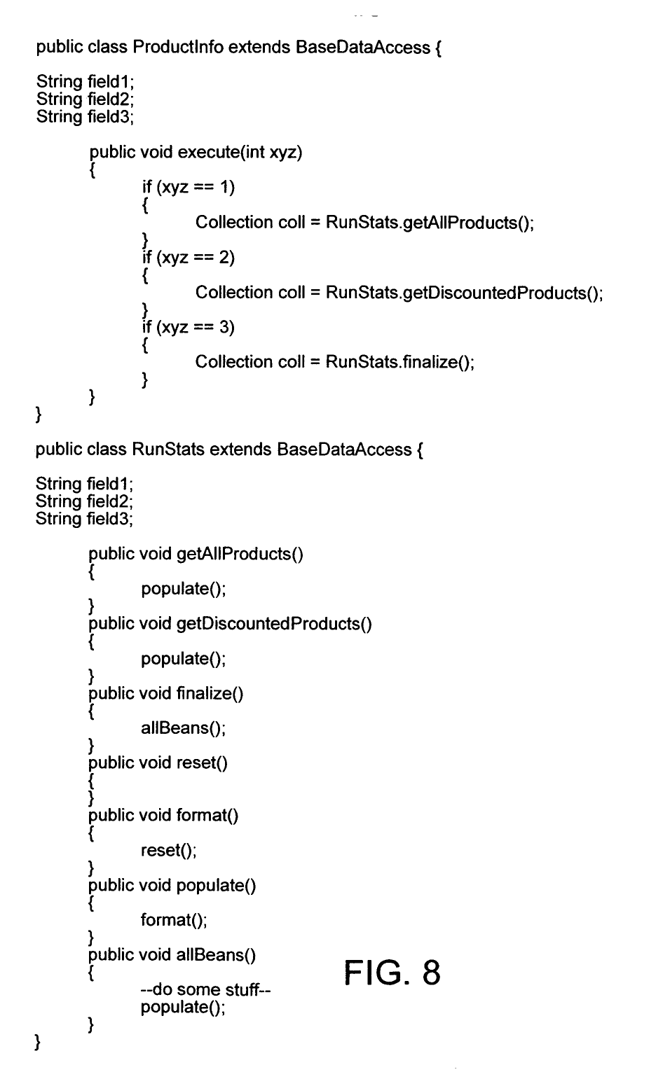

An example is now presented to illustrate the concepts discussed above. Referring to FIG. 8, pseudo-code of a very simple example is provided to show the function of the profiler in accordance with the preferred embodiments. The pseudo-code in FIG. 8 defines a ProductInfo class as a subclass of a BaseDataAccess class. The ProductInfo class includes an execute() method that calls three different methods in the RunStats class depending upon the value of the xyz parameter passed to the execute method. A RunStats class is also defined that is a subclass of the BaseDataAccess class. The RunStats class includes methods getAllProducts(), getDiscountedProducts(), finalize(), reset(), format(), populate(), and allBeans(). We now show the call stack for the pseudo-code shown in FIG. 8.

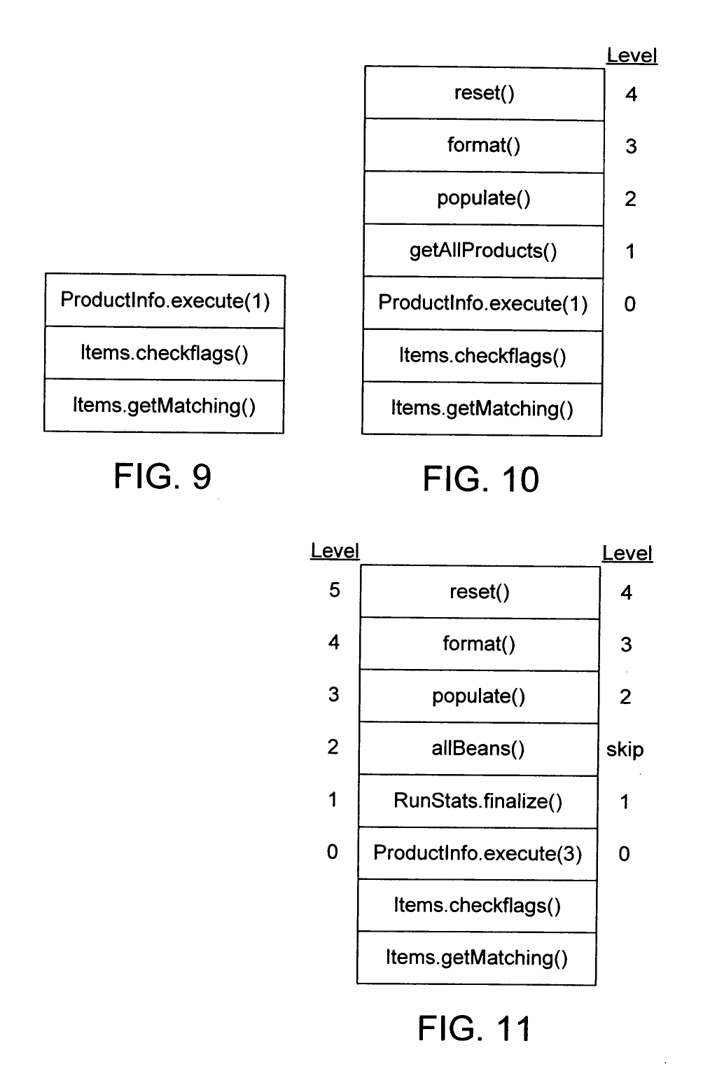

Referring to FIG. 9, a call stack for the pseudo-code in FIG. 8 assumes a method getMatching() in a class Items called a method checkflags() in the Items class, which called the execute() method in the ProductInfo class, passing a 1 as a parameter. With the sample trigger specification 310 in FIG. 3, the profiler begins collecting profile data when the execute() method in the ProductInfo class is invoked. The stack frame for the current method (ProductInfo.execute()) is assigned a level of zero, as shown in FIG. 10. With the passed parameter xyz of 1, the execute method calls the getAllProducts() method on the RunStats class, which is the first level (level 1) past the level where the profiler began collecting profile data (level 0). The getAllProducts() method calls the populate method, which results in the stack frame for populate() being added to the stack at level 2 in FIG. 10. The populate() method calls the format() method, which results in the stack frame for format() being added to the stack at level 3 in FIG. 10. The format() method calls the reset() method, which results in the stack frame for reset() being added to the call stack at level 4 in FIG. 10. Note that the call stack in FIG. 10 represents the state of the call stack during execution of the reset() method. If we assume the level specification is 4 as shown at 410 in FIG. 4, the profiler will collect profile data for the methods at all of the levels 0-4 in FIG. 10, because they all have a level that is less than or equal to the level specification.

Now we consider an example where the execute() method on the ProductInfo class is invoked with a parameter of 3. The resulting call stack during execution of the reset() method is shown in FIG. 11. The execute() method calls the RunStats.finalize() method, which calls the allBeans() method, which calls the populate() method, which calls the format() method, which calls the reset() method. The level indication on the left side of FIG. 11 assumes either no skip specification or a skip specification that specifies to skip none of the methods shown in FIG. 11. As a result, the profiler collects profile data for each of the methods between levels 0 and 4 shown on the left side of FIG. 11. When the reset() method is invoked, this is the fifth level, which is outside of the level specification of 4. As a result, the profiler does not collect profile data for the reset() method.

The level indication on the right side of FIG. 11 assumes a skip specification 530 shown in FIG. 5. Note that any of the sample skip specifications 510, 520 or 530 in FIG. 5 will result in skipping the allBeans() method. As a result, the stack frame for allBeans() is skipped, meaning that no profile data is collected for allBeans(), and the level is not counted against the level specification. As a result, the next method populate() is assigned a level of 2 because the stack frame for allBeans() was skipped. As a result of specifying the skip specification as shown at 530 in FIG. 5, the profiler now skips allBeans(), and collects profile data for the ProductInfo.execute() method (level 0), the RunStats.finalize() method (level 1), the populate method (level 2), the format method (level 3), and the reset method (level 4). If the reset method called another method, the level would be 5, so the profiler would not collect profile data for any further levels. Note that the profiler continues collecting profile data until stack frame for the ProductInfo.execute() method is popped off the call stack after execution of this method is complete. At this point, the level is −1, so the profiler halts collecting profile data.

The preferred embodiments provide enhanced profiling capability by specifying a trigger specification for starting the collection of profile data, by specifying a level specification for determining how many frames deep on the call stack to go beyond the current stack frame, and by optionally specifying a skip specification that specifies one or more methods to skip. When a method is skipped, the profiler does not collect profile data for the skipped method, and the level of the stack frame for the skipped method is not counted against the level specification. The result is a very powerful profiler that produces desired profile data while minimizing the amount of extraneous data or data of lower relevance.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

1. An apparatus comprising:
at least one processor;
a memory coupled to the at least one processor;
a computer program residing in the memory; and
a profiler residing in the memory and executed by the at least one processor, the profiler collecting profile data as the computer program executes based on a trigger specification that determines when to start collecting the profile data and based on a level specification that determines a number of levels deep from a current stack frame in a call stack to collect the profile data.

2. The apparatus of claim 1 wherein the collecting of the profile data by the profiler is further based on a skip specification that specifies at least one method to skip in the call stack.

3. The apparatus of claim 2 wherein the profiler does not collect profile data for a method that satisfies the skip specification.

4. The apparatus of claim 2 wherein a method that satisfies the skip specification does not count against the number of levels specified in the level specification.

5. The apparatus of claim 1 wherein the current stack frame is assigned a number, and the profiler continues collecting the profile data until a stack frame with the assigned number minus one is encountered.

6. The apparatus of claim 1 wherein the trigger specification comprises a specification of an object oriented method, wherein the profiler starts collecting the profile data when the object oriented method is executed.

7. A computer-implemented method for collecting profile data for a computer program, the method comprising the steps of:
(A) executing the computer program;
(B) determining when to start collecting the profile data based on a trigger specification; and
(C) determining a number of levels deep from a current stack frame in a call stack to collect the profile data.

8. The method of claim 7 further comprising the step of:
(D) determining at least one method to skip in the call stack based on a skip specification.

9. The method of claim 8 further comprising the step of not collecting profile data for a method that satisfies the skip specification.

10. The method of claim 8 wherein a method that satisfies the skip specification does not count against the number of levels specified in the level specification.

11. The method of claim 7 further comprising the steps of:
assigning the current stack frame a number; and
collecting the profile data until a stack frame with the assigned number minus one is encountered.

12. The method of claim 7 wherein the trigger specification comprises a specification of an object oriented method, wherein the collecting the profile data in step (B) starts when the object oriented method is executed.

13. A computer-readable program product comprising:
(A) a profiler that collects profile data as a computer program executes based on a trigger specification that determines when to start collecting the profile data and based on a level specification that determines a number of levels deep from a current stack frame in a call stack to collect the profile data; and
(B) computer-readable signal bearing media bearing the profiler.

14. The program product of claim 13 wherein the signal bearing media comprises recordable media.

15. The program product of claim 13 wherein the at least one user-specified criterion specifies to group the at least two threads according to thread type.

16. The program product of claim 13 wherein the collecting of the profile data by the profiler is further based on a skip specification that specifies at least one method to skip in the call stack.

17. The program product of claim 16 wherein the profiler does not collect profile data for a method that satisfies the skip specification.

18. The program product of claim 16 wherein a method that satisfies the skip specification does not count against the number of levels specified in the level specification.

19. The program product of claim 13 wherein the current stack frame is assigned a number, and the profiler continues collecting the profile data until a stack frame with the assigned number minus one is encountered.

20. The program product of claim 13 wherein the trigger specification comprises a specification of an object oriented method, wherein the profiler starts collecting the profile data when the object oriented method is executed.
